(19) United States
(12) Patent Application Publication
(10) Pub. No.: US 2025/0313193 A1
(43) Pub. Date: Oct. 9, 2025

(54) AUTOMATIC PARKING ASSISTANCE DEVICE AND AUTOMATIC PARKING ASSISTANCE SYSTEM

(71) Applicant: TOYOTA JIDOSHA KABUSHIKI KAISHA, Toyota-shi (JP)

(72) Inventor: Naoya SAIKA, Nagoya-shi (JP)

(73) Assignee: TOYOTA JIDOSHA KABUSHIKI KAISHA, Toyota-shi (JP)

(21) Appl. No.: 19/073,575

(22) Filed: Mar. 7, 2025

(30) Foreign Application Priority Data
Apr. 3, 2024 (JP) 2024-060278

(51) Int. Cl. B60W 30/06

(52) U.S. Cl. CPC B60W 30/06; B60W 2540/215

(57) ABSTRACT

An automatic parking assistance device includes a subject vehicle position determination unit, a parking direction determination unit, and a controller. The subject vehicle position determination unit determines whether a center line of a parking space is located on an advancing side or a retreating side of a vehicle with respect to a reference point of the vehicle. When the center line of a target parking space is determined to be located on the advancing side with respect to the reference point of the vehicle, the parking direction determination unit decides a parking direction to be forward. When the center line of the target parking space is determined to be located on the retreating side, the parking direction determination unit decides the parking direction to be backward. The controller autonomously parks the vehicle in the target parking space according to the decided parking direction.

### CROSS-REFERENCE TO RELATED APPLICATIONS

This application is based upon and claims the benefit of priority from Japanese Patent Application No. 2024-060278, filed on Apr. 3, 2024, the entire contents of which are incorporated herein by reference.

### BACKGROUND

### 1. Field

The following description relates to an automatic parking assistance device and an automatic parking assistance system.

### 2. Description of Related Art

Japanese Laid-Open Patent Publication No. 2022-111180 discloses a parking assist device that automatically decides a parking posture of a subject vehicle in a parking space. The parking assistance device uses a periphery monitoring sensor to obtain parking directions of ambient vehicles that are already parked, and adopts the most common parking direction as the parking posture of the subject vehicle.

The above parking assistance device cannot decide the parking posture that reflects the intention of the user. Also, the parking assistance device cannot decide the parking posture when there is no vehicle parked in the vicinity.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an automatic parking assistance device is installed in a vehicle and is configured to autonomously move the vehicle to a parking space and park the vehicle. The automatic parking assistance device includes processing circuitry. In response to an instruction by a user to switch to an automatic parking mode, the processing circuitry is configured to recognize a parking space. The processing circuitry is configured to obtain a parking frame line that defines the recognized parking space, and a center line that corresponds to the parking space. The center line indicates a center of the parking space and is parallel to a longitudinal direction of the parking frame line that defines the parking space. The processing circuitry is configured to determine whether the center line of the parking space is located on an advancing side or a retreating side of the vehicle with respect to a reference point of the vehicle. The reference point indicates a position of a driver seat of the vehicle. In response to the user selecting a target parking space from the recognized parking space, when the center line of the target parking space is determined to be located on the advancing side of the vehicle with respect to the reference point of the vehicle, the processing circuitry is configured to decide a parking direction to be forward. When the center line of the target parking space is determined to be located on the retreating side of the vehicle with respect to the reference point of the vehicle, the processing circuitry is configured to decide the parking direction to be backward. The processing circuitry is configured to compute a travel route based on the decided parking direction. The processing circuitry is configured to autonomously move the vehicle to the target parking space and park the vehicle.

In another general aspect, an automatic parking assistance system includes the above automatic parking assistance device and a portable terminal. The portable terminal is configured to communicate with the vehicle from outside the vehicle when associated with the vehicle in advance. The portable terminal is configured to obtain, from the vehicle, information related to the decided parking direction. When the portable terminal receives the information related to the parking direction, based on operation of the portable terminal by the user, the portable terminal is configured to notify the processing circuitry of an instruction to start automatic parking that autonomously moves the vehicle to the parking space selected as the target parking space and park the vehicle. The processing circuitry is configured to start the automatic parking in response to the instruction from the portable terminal.

Other features and aspects will be apparent from the following detailed description, the drawings, and the claims.

### BRIEF DESCRIPTION OF THE DRAWINGS

FIG. 1 is a diagram showing a configuration of a vehicle including an automatic parking assistance device in accordance with a first embodiment.

FIG. 2 is a flowchart illustrating a flow of automatic parking assistance in accordance with the first embodiment.

FIG. 3 is a diagram illustrating an example in which the automatic parking assistance device automatically decides a parking direction in accordance with the first embodiment.

FIG. 4 is a diagram showing a display example of parking directions in parking spaces.

FIG. 5 is a diagram showing a configuration of an automatic parking assistance system including an automatic parking assistance device and a portable terminal in accordance with a second embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

Hereinafter, an automatic parking assistance device 10 according to a first embodiment will be described with reference to the drawings.

Each Configuration for Automatic Parking Assistance Including Automatic Parking Assistance Device 10

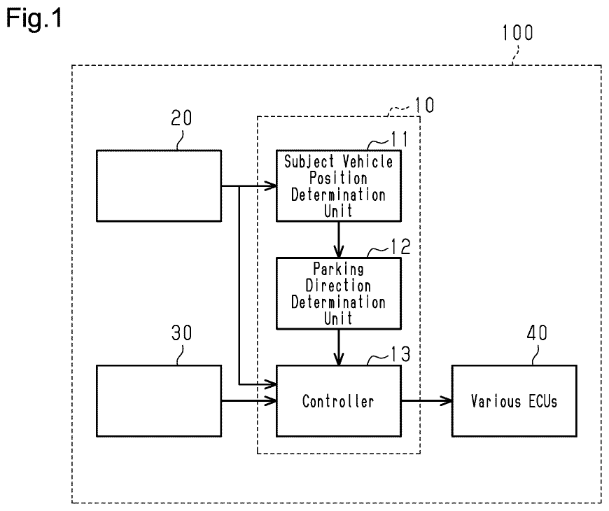

FIG. 1 shows a configuration of a vehicle 100 including an automatic parking assistance device 10 in accordance with the first embodiment. FIG. 1 particularly shows each configuration for automatic parking assistance in the vehicle 100.

The vehicle 100 includes an automatic parking assistance device 10, a periphery monitoring sensor 20, a vehicle state sensor 30, and various types of ECUs 40. The automatic parking assistance device 10, the periphery monitoring sensor 20, the vehicle state sensor 30, and the various types of ECUs 40 constitute each configuration for automatic parking assistance in the vehicle 100.

The periphery monitoring sensor 20 detects an object around the vehicle 100 and outputs a detection result to the automatic parking assistance device 10. The periphery monitoring sensor 20 is, for example, a camera. The periphery monitoring sensor 20 may include an ultrasonic sensor, a radar, a laser scanner, and the like. The camera captures an image of the surroundings of the vehicle. The ultrasonic sensor emits an ultrasonic wave and receives the ultrasonic wave reflected by an object. The radar emits a laser beam or a millimeter wave and receives the laser beam or the millimeter wave reflected by an object. The laser scanner scans a predetermined range with a laser and receives the laser reflected by an object.

The periphery monitoring sensor 20 captures an image of the periphery of the vehicle 100 by a camera. The periphery monitoring sensor 20 outputs the captured image to the automatic parking assistance device 10.

The vehicle state sensor 30 detects a vehicle speed, a steering angle, a position of a shift lever, an operation state of a parking brake, and the like as vehicle state information, and outputs a detection result to the automatic parking assistance device 10.

The automatic parking assistance device 10 includes a subject vehicle position determination unit 11, a parking direction determination unit 12, and a controller 13. The subject vehicle position determination unit 11 can acquire a parking frame line that defines a parking space located around the vehicle 100 from the image captured by the periphery monitoring sensor 20. Accordingly, the subject vehicle position determination unit 11 can determine the positional relationship between the vehicle 100 and the parking space.

The parking direction determination unit 12 can determine the parking direction based on the positional relationship between the vehicle 100 and the parking space determined by the subject vehicle position determination unit 11.

The controller 13 can calculate a travel route according to the parking direction determined by the parking direction determination unit 12, and autonomously move the vehicle 100 to the parking space selected as the target parking space and park the vehicle 100 in the parking space.

Various ECUs 40 can manage the motion of the vehicles 100 by performing overall control on the vehicles 100. The various types of ECUs 40 can adjust the traveling speed and the traveling direction of the vehicles 100.

### Processing by Automatic Parking Assistance Device 10

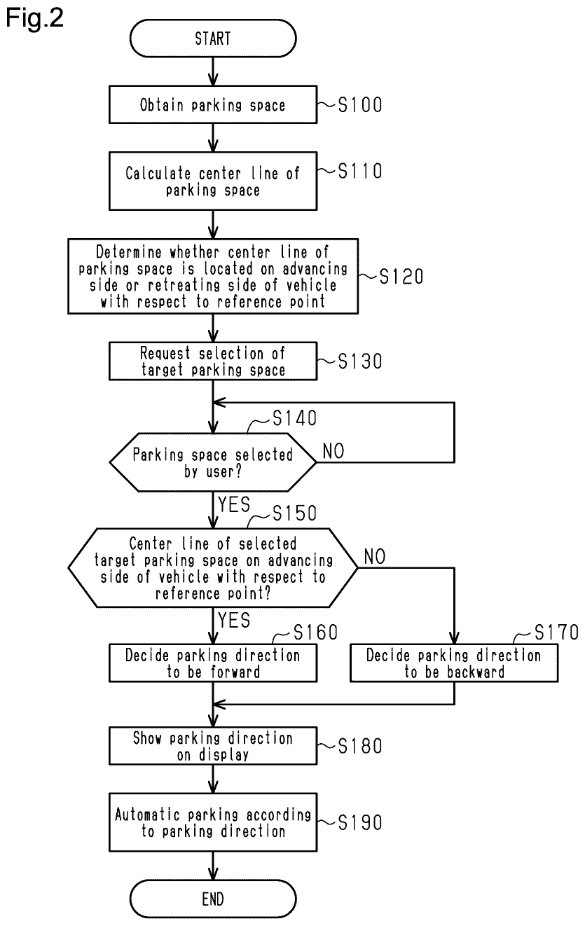

Hereinafter, a flow of processing performed by the automatic parking assistance device 10 will be specifically described with reference to FIG. 2.

FIG. 2 is a flowchart illustrating a flow of the automatic parking assistance in accordance with the first embodiment. This series of processes is executed in response to an instruction from the user to switch the vehicle 100 to the automatic parking mode. As shown in FIG. 2, when the series of processes is started, the automatic parking assistance device 10 first acquires information indicating a plurality of parking spaces in step S100.

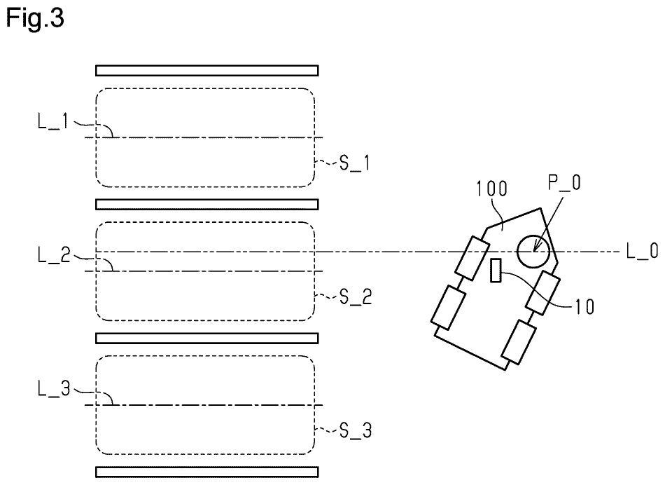

Specifically, as shown in FIG. 3, the subject vehicle position determination unit 11 recognizes parking spaces S_1, S_2, and S_3 located in vicinity of the vehicle 100 from an image captured by the periphery monitoring sensor 20. The subject vehicle position determination unit 11 obtains the parking frame lines that respectively define the recognized parking spaces S_1, S_2, and S_3. FIG. 3 shows an example in which three parking spaces S_1, S_2, and S_3 are present in the vicinity of the vehicle 100. After step S100, the automatic parking assistance device 10 proceeds to step S110.

In step S110, the subject vehicle position determination unit 11 calculates center lines L_1, L_2, and L_3 that respectively correspond to the recognized parking spaces S_1, S_2, and S_3. The center lines L_1, L_2, and L_3 are each parallel to a longitudinal direction of a corresponding one of the parking frame lines and indicate the center of a corresponding one of the parking spaces.

The automatic parking assistance device 10 shows the information illustrated in FIG. 3 on a display of the vehicle 100. FIG. 3 shows the parking frame lines that respectively define the recognized parking spaces S_1, S_2, and S_3, and center lines L_1, L_2, and L_3 that respectively correspond to the recognized parking spaces S_1, S_2, and S_3.

Next, the subject vehicle position determination unit 11 proceeds to step S120. In step S120, the subject vehicle position determination unit 11 determines the positional relationship of the subject vehicle 100 and the parking spaces S_1, S_2, and S_3. As shown in FIG. 3, the position of the driver seat of the vehicle 100 serves as reference point P_0 of the vehicle 100. A line that is parallel to the longitudinal direction of the parking frame line and extends through the reference point P_0 serves as reference line L_0. The subject vehicle position determination unit 11 determines, for each of the parking spaces S_1, S_2, and S_3, whether the center line L_1, L_2, or L_3 is located on the advancing side or the retreating side of the vehicle 100 with respect to the reference line L_0. The subject vehicle position determination unit 11 stores the determination results for the parking spaces S_1, S_2, and S_3.

Then, the automatic parking assistance device 10 proceeds to step S130. In step S130, the automatic parking assistance device requests the user to select a target parking space. Specifically, the automatic parking assistance device 10 may show on the display a message that prompts the user to selection a target parking space. Alternatively, the automatic parking assistance device 10 may issue the message by voice from a speaker. In this manner, the automatic parking assistance device 10 prompts the user to select one parking space from the parking spaces S_1, S_2, and S_3 shown on the display. When the display also serves as an input device, such as a touch panel, the user touches the display to select one of the parking spaces S_1, S_2, and S_3 shown on the display. The parking pace may be selected using voice recognition.

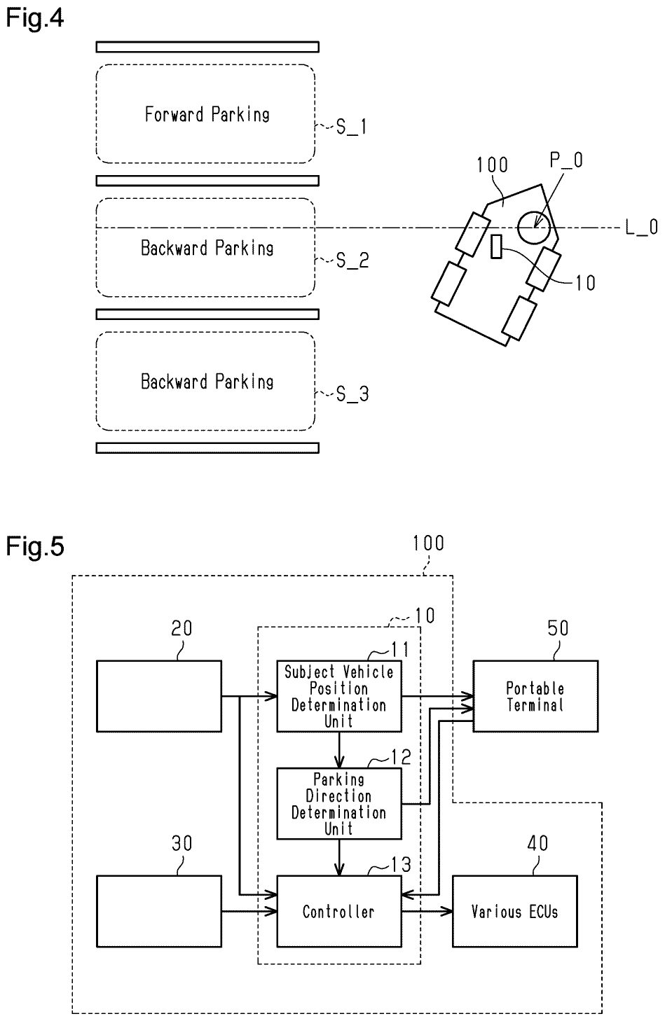

As shown in FIG. 4, the automatic parking assistance device 10 may show, on the display, whether the parking direction in each of the recognized parking spaces S_1, S_2, and S_3 would be forward or backward when selected as the target parking space. This allows the user to select the target parking space while recognizing whether the vehicle 100 would be parked forward or backward.

Then, the automatic parking assistance device 10 proceeds to step S140. In step S140, the automatic parking assistance device 10 determines whether the user has selected one of the parking spaces S_1, S_2, and S_3 as the target parking space. When the user has selected one parking space as the target parking space (step S140: YES), the automatic parking assistance device 10 proceeds to step S150. When the user has not selected any parking space (step S140: NO), the automatic parking assistance device 10 repeats step S140.

In step S150, the subject vehicle position determination unit 11 determines whether the center line of the parking space selected as the target parking space is on the advancing side of the vehicle 100 with respect to the reference point P_0 of the vehicle 100. When it is determined that the center line is located on the advancing side of the vehicle 100 (step S150: YES), the automatic parking assistance device 10 proceeds to step S160. In step S160, the parking direction determination unit 12 decides the parking direction to be forward. When it is determined that the center line is not located on the advancing side of the vehicle 100 (step S150: NO), the automatic parking assistance device 10 proceeds to step S170. In step S170, the parking direction determination unit 12 decides the parking direction to be backward. Then, the automatic parking assistance device 10 proceeds to step S180.

In step S180, the automatic parking assistance device 10 shows the parking direction decided in step S160 or step S170 on the display. The automatic parking assistance device 10 may notify the user of the decided parking direction by voice from a speaker.

Next, the automatic parking assistance device 10 proceeds to step S190. In step S190, the controller 13 computes a travel route based on the parking direction decided in step S160 or S170. Then, the controller 13 autonomously moves the vehicle 100 to the target parking space selected by the user and parks the vehicle 100 in the target parking space according to the computed travel route.

### Operation of First Embodiment

The automatic parking assistance device 10 is mounted on a vehicle 100, and autonomously moves the vehicle 100 to a parking space and parks the vehicle 100. The automatic parking assistance device 10 includes a subject vehicle position determination unit 11, a parking direction determination unit 12, and a controller 13. The subject vehicle position determination unit 11 recognizes the parking spaces S_1, S_2, and S_3 in response to a user's instruction to switch the vehicle 100 to the automatic parking mode. The subject vehicle position determination unit 11 acquires a plurality of parking frame lines respectively defining the plurality of recognized parking spaces S_1, S_2, and S_3 and a plurality of center lines L_1, L_2, and L_3. Each of the plurality of center lines L_1, L_2, and L_3 indicates the center of a corresponding one of the plurality of parking spaces S_1, S_2, and S_3, and is parallel to the longitudinal direction of the corresponding parking frame line. The subject vehicle position determination unit 11 determines whether the plurality of center lines L_1, L_2, and L_3 are positioned on the advancing side or the retreating side with respect to a reference point P_0 of the vehicle 100 indicating the position of the driver seat of the vehicle 100. When the user selects one of the recognized parking spaces S_1, S_2, and S_3 as the target parking space, the parking direction determination unit 12 determines the parking direction. Specifically, when the subject vehicle position determination unit 11 determines that the center line of the target parking space is positioned on the advancing side with respect to the reference point P_O of the vehicle 100, the parking direction determination unit 12 determines the parking direction to be forward. On the other hand, when the subject vehicle position determination unit 11 determines that the center line of the target parking space is positioned on the retreating side with respect to the reference point P_O of the vehicle 100, the parking direction determination unit 12 determines the parking direction to be backward. The controller 13 calculates a travel route in accordance with the parking direction determined by the parking direction determination unit 12, and autonomously moves and parks the vehicle 100 in the parking space selected as the target parking space.

For example, in the case of the example shown in FIG. 3, the subject vehicle position determination unit 11 determines that the center line L_1 of the parking space S_1 is positioned on the advancing side with respect to the reference point P_0 of the vehicle 100. Thus, when the user selects the parking space S_1 as the target parking space, the parking direction determination unit 12 determines the parking direction of the parking space S_1 to be forward. In addition, the controller 13 causes the vehicle 100 to autonomously enter the parking space S_1 in the forward direction and to be parked forward according to the forward parking.

On the other hand, the subject vehicle position determination unit 11 determines that the center lines L_2 and L_3 of the parking spaces S_2 and S_3 are positioned on the retreating side with respect to the reference point P_0 of the vehicle 100. Thus, when the user selects the parking spaces S_2 and S_3 as the target parking spaces, the parking direction determination unit 12 determines the parking direction of the parking space S_2 or S_3 to be backward. The controller 13 causes the vehicle 100 to autonomously enter the parking space S_2 or S_3 in the backward direction and park the vehicle 100 backward according to the backward parking.

### Effects of First Embodiment

(1) When the user who is driving the vehicle 100 temporarily stops the vehicle 100 such that a parking space where the user wants to park the vehicle 100 is located on the advancing side of the user, the user intends to park the vehicle 100 forward. On the other hand, when the user temporarily stops the vehicle 100 such that the parking space in which the user wants to park the vehicle 100 is located on the retreating side of the user, the user intends to park the vehicle 100 backward. When the center line of the target parking space selected by the user is positioned on the advancing side with respect to the position of the driver seat which is the reference point P_O of the vehicle 100, the automatic parking assistance device 10 determines the parking direction to be forward. On the other hand, in a case where the center line of the target parking space selected by the user is positioned on the retreating side with respect to the position of the driver seat which is the reference point P_O of the vehicle 100, the automatic parking assistance device 10 determines the parking direction to be backward. In this way, by reflecting the intention of the user in the position of the vehicle 100 when the vehicle 100 is temporarily stopped with respect to the target parking space, the parking direction can be uniquely determined by reflecting the intention of the user. In addition, since only the positional relationship between the target parking space and the position of the vehicle 100 is used, it is possible to automatically determine the parking direction even when there is no vehicle parked in the vicinity.

(2) The automatic parking assistance device 10 causes the display to display the plurality of parking frame lines respectively defining the plurality of recognized parking spaces S_1, S_2, and S_3 and the plurality of center lines L_1, L_2, and L_3 respectively corresponding to the plurality of recognized parking spaces S_1, S_2, and S_3.

Thus, even when it is difficult for the user to visually recognize the position of the vehicle 100 with respect to the center lines L_1, L_2, and L_3, the user can correctly grasp the center lines L_1, L_2, and L_3 and the position of the vehicle 100 by the display. Therefore, the user can easily reflect his/her intention in the determination of the parking direction by operating the position of the vehicle 100.

(3) The automatic parking assistance device 10 displays whether the parking direction in a case where each of the plurality of recognized parking spaces S_1, S_2, and S_3 is selected as the target parking space is forward or backward on the display provided in the vehicle 100, and prompts the user to select the target parking space.

Thus, the user can select the target parking space after recognizing whether the forward parking or the backward parking is performed.

### Second Embodiment

Hereinafter, an automatic parking assistance system including the automatic parking assistance device 10 and the portable terminal 50 according to the second embodiment will be described with reference to FIG. 5.

### Configuration of Automatic Parking Assistance System

FIG. 5 is a diagram illustrating a configuration of an automatic parking assistance system including the automatic parking assistance device 10 and the portable terminal 50 according to the second embodiment. The automatic parking assistance device 10 is an automatic parking assistance device in accordance with the first embodiment. That is, the second embodiment is the same as the first embodiment except that the second embodiment further includes the portable terminal 50.

The portable terminal 50 is, for example, a smartphone, a tablet, or the like, and includes a display device that also serves as an input device such as a touch panel type. The portable terminal 50 establishes a wireless communication connection with the vehicle 100 in advance, and can communicate with the vehicle 100 from the outside of the vehicle 100. In the second embodiment, the user causes the portable terminal 50 to communicate with the automatic parking assistance device 10 by activating the automatic parking application installed in the portable terminal 50.

Specifically, when the user activates the automatic parking application installed in the portable terminal 50, the portable terminal 50 starts communication with the automatic parking assistance device 10. When the automatic parking application is activated, as illustrated in FIG. 5, the portable terminal 50 acquires information regarding the positional relationship between the vehicle 100 and the parking spaces S_1, S_2, and S_3 from the subject vehicle position determination unit 11. Further, the portable terminal 50 acquires information on the parking direction from the parking direction determination unit 12. When the portable terminal 50 acquires the information on the parking direction, the user operates the portable terminal 50 to select the target parking space. The portable terminal 50 transmits information on the result selected by the user to the automatic parking assistance device 10, and notifies the controller 13 of an instruction to start automatic parking in which the vehicle 100 is autonomously moved to and parked in the parking space selected as the target parking space.

In response to an instruction from the portable terminal 50 to start automatic parking, the controller 13 autonomously moves the vehicle 100 to the parking space selected as the target parking space and parks the vehicle 100 in the parking space.

In the case of this automatic parking assistance system, the user can get off the vehicle 100 and select the target parking space by the portable terminal 50 from the outside of the vehicle in a state where the vehicle 100 is temporarily stopped around the parking space.

In the second embodiment, the series of processes shown in FIG. 2 is changed as follows.

In step S130, the automatic parking assistance device 10 causes the portable terminal 50 to display a request for the user to select a target parking space.

In step S140, the automatic parking assistance device 10 receives the result selected by the user from the portable terminal 50.

FIG. 4 is a diagram showing a state in which the parking directions of the parking spaces S_1, S_2, and S_3 are displayed on the portable terminal 50 according to the second embodiment. As shown in FIG. 4, the portable terminal 50 displays the parking frame lines defining the parking spaces S_1, S_2, and S_3, the position of the vehicle 100, and the information of the parking direction when the parking space is selected as the target parking space. As shown in FIG. 4, the portable terminal 50 displays forward parking as the information of the parking direction when the parking space S_1 is selected as the target parking space. The portable terminal 50 displays backward parking as the information of the parking direction in a case where one of the parking spaces S_2 and S_3 is selected as the target parking space.

The user touches and selects one of the parking spaces S_1, S_2, and S_3 displayed on the portable terminal 50. By this operation, the controller 13 is notified of an instruction to start automatic parking in which the vehicle 100 is autonomously moved to and parked in the parking space selected as the target parking space.

### Operation of Second Embodiment

In the above-described automatic parking assistance system, the portable terminal 50 acquires information on the parking direction determined by the parking direction determination unit 12 from the vehicle 100. When the portable terminal 50 acquires the information on the parking direction, the portable terminal 50 notifies the controller 13 of an instruction to start automatic parking in which the vehicle 100 is autonomously moved to and parked in the parking space selected as the target parking space based on the operation of the portable terminal 50 by the user. In response to the instruction from the portable terminal 50, the controller 13 moves the vehicle 100 to the parking space selected as the target parking space and parks the vehicle 100.

### Advantages of Second Embodiment

(1) In the above-described automatic parking assistance system, when the portable terminal 50 acquires the information regarding the parking direction, the portable terminal 50 notifies the controller 13 of the instruction to start automatic parking based on the operation of the portable terminal 50 by the user, and the controller 13 performs automatic parking in response to the instruction from the portable terminal 50. In this way, the user can perform automatic parking by remotely operating the vehicle 100, and convenience is improved.
(2) In the above-described automatic parking assist system, the portable terminal 50 acquires and displays the parking frame line, the position of the vehicle 100, and the information of the parking direction when selected, from the vehicle 100, and prompts the user to select the target parking space by the operation of the portable terminal 50 by the user. Accordingly, the user can select the target parking direction after recognizing the parking direction in a case where each of the parking spaces S_1, S_2, and S_3 is selected as the target parking space from the outside of the vehicle 100 using the portable terminal 50. Therefore, the user can reflect his/her intention without fail.

The second embodiment may be modified as follows. The above embodiments and the following modifications can be combined as long as they remain technically consistent with each other.

In the above-described second embodiment, the portable terminal 50 displays the information of the parking direction in a case where each of the parking spaces S_1, S_2, and S_3 is selected. However, when the user selects one of the parking spaces S_1, S_2, and S_3 recognized by the vehicle 100 as the target parking space, the parking direction determined only for the selected parking space may be displayed on the portable terminal 50. Even in such an aspect, the user can grasp the parking direction of the parking space selected as the target parking space before the parking is performed. When the target parking space is selected, the parking direction may be displayed on the portable terminal 50, a display for confirming whether or not the automatic parking may be executed may be performed, and the automatic parking may be started when the user performs an operation of determining the execution with respect to the display.

In the first and second embodiments, the automatic parking assistance device 10 includes a central processing unit (CPU), a random access memory (RAM), and a read only memory (ROM). The automatic parking assistance device 10 executes software processing. However, such a configuration is merely an example. For example, the automatic parking assistance device 10 may include a dedicated hardware circuit that processes at least a part of the software processing executed in the above-described embodiment. The dedicated hardware circuit is, for example, an application specific integrated circuit (ASIC). That is, the automatic parking assistance device 10 may have any one of the following configurations (a) The automatic parking assistance device 10 includes a processing device that executes all processes according to a program, and a program storage device such as a ROM that stores the program. That is, the automatic parking assistance device 10 includes a software execution device. (b) The automatic parking assistance device 10 includes a processing device that executes a part of processing according to a program, and a program storage device. Further, the automatic parking assistance device 10 includes a dedicated hardware circuit that executes the remaining processing. (c) The automatic parking assistance device 10 includes a dedicated hardware circuit that executes all processes. There may be more than one software execution device and/or more than one dedicated hardware circuit. Specifically, the above-described processes may be executed by processing circuitry including at least one of a software execution device and a dedicated hardware circuit. The processing circuitry may include more than one software execution device and more than one dedicated hardware circuit. The program storage device, or computer-readable medium, includes any type of storage device that is a medium accessible by a versatile computer or a dedicated computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An automatic parking assistance device installed in a vehicle and configured to autonomously move the vehicle to a parking space and park the vehicle, the automatic parking assistance device comprising:
processing circuitry,
wherein, in response to an instruction by a user to switch to an automatic parking mode, the processing circuitry is configured to:
recognize a parking space;
obtain a parking frame line that defines the recognized parking space, and a center line that corresponds to the parking space, the center line indicating a center of the parking space and being parallel to a longitudinal direction of the parking frame line that defines the parking space;
determine whether the center line of the parking space is located on an advancing side or a retreating side of the vehicle with respect to a reference point of the vehicle, the reference point indicating a position of a driver seat of the vehicle; and
in response to the user selecting a target parking space from the recognized parking space, when the center line of the target parking space is determined to be located on the advancing side of the vehicle with respect to the reference point of the vehicle, decide a parking direction to be forward, and when the center line of the target parking space is determined to be located on the retreating side of the vehicle with respect to the reference point of the vehicle, decide the parking direction to be backward;
compute a travel route based on the decided parking direction; and
autonomously move the vehicle to the target parking space and park the vehicle.

2. The automatic parking assistance device according to claim 1, wherein the processing circuitry is configured to cause a display included in the vehicle to show the parking frame line that defines the recognized parking space, and the center line that corresponds to the recognized parking space.

3. The automatic parking assistance device according to claim 2, wherein the processing circuitry is configured to prompt the user to select the target parking space by showing, on the display, whether the parking direction in the recognized parking space would be forward or backward when selected as the target parking space.

4. Automatic parking assistance system, comprising:
the automatic parking assistance device according to claim 1; and
a portable terminal configured to communicate with the vehicle from outside the vehicle when associated with the vehicle in advance, wherein
the portable terminal is configured to obtain, from the vehicle, information related to the decided parking direction,
when the portable terminal receives the information related to the parking direction, based on operation of the portable terminal by the user, the portable terminal is configured to notify the processing circuitry of an instruction to start automatic parking that autonomously moves the vehicle to the parking space selected as the target parking space and park the vehicle; and
the processing circuitry is configured to start the automatic parking in response to the instruction from the portable terminal.

5. The automatic parking assistance system according to claim 4, wherein:
the portable terminal is configured to obtain, from the vehicle, and show the parking frame line that defines the recognized parking space, a position of the vehicle, and information that indicates the parking direction when the parking space is selected as the target parking space; and
the portable terminal is configured to prompt the user to select the target parking space from the recognized parking space through operation of the portable terminal.
